(19) United States
(12) Patent Application Publication
(10) Pub. No.: US 2022/0362706 A1
(43) Pub. Date: Nov. 17, 2022

(54) INTEGRATED AMMONIA-BASED DESULFURIZATION AND DECARBONIZATION APPARATUS AND METHOD

(71) Applicant: Jiangnan Environmental Protection Group Inc., Grand Cayman (KY)

(72) Inventors: Jun Zhang, Nanjing (CN); Jing Luo, Nanjing (CN)

(21) Appl. No.: 17/709,945

(22) Filed: Mar. 31, 2022

Related U.S. Application Data
(63) Continuation of application No. 17/688,091, filed on Mar. 7, 2022, now abandoned.

(30) Foreign Application Priority Data
May 11, 2021 (CN) 202110510852.5

(51) Int. Cl. B01D 53/14; B01D 53/18; C02F 1/44; C05C 3/00; C05C 9/00; C05D 9/02; C05D 1/00

(52) U.S. Cl. CPC B01D 53/1406; B01D 53/1475; B01D 53/1481; B01D 53/185; C02F 1/44; B01D 53/1418; C05C 3/00; C05C 9/00; C05D 9/02; C05D 1/00; B01D 2252/103; C02F 2101/101

(57) ABSTRACT

Apparatus and methods for desulfurization and decarbonization of a process gas containing sulfur oxides and CO₂. Ammonia may be used as a desulfurizing and decarbonizing agent. The gas may enter a desulfurization apparatus for desulfurization, and to produce an ammonium sulfate fertilizer. The desulfurized gas may enter a decarbonization apparatus to remove carbon dioxide in the gas, and to produce an ammonium bicarbonate fertilizer. The decarbonized gas may contain free ammonia. The decarbonized gas may be washed with a desulfurization circulating fluid and then with water. The washing fluid may be returned to the desulfurization apparatus for use as an absorbing agent for desulfurization. Acidic desulfurization circulating fluid may be used to wash ammonia, thereby achieving a high ammonia washing efficiency, and a low ammonia slip during the decarbonization process.

This application claims priority under 35 U.S.C. § 119 of Chinese Patent Application No. 202110510852.5, filed on May 11, 2021, which is hereby incorporated in its entirety herein.

### TECHNICAL FIELD

The disclosure relates to the technical field of environmental protection, and in particular, relates to apparatus and methods for removal of sulfur oxides and CO₂ using ammonia.

### BACKGROUND

Gas species in the air, such as CO₂ and methane, may let shortwave solar radiation pass through, but can block longwave radiation from the earth surface to the cosmic space. With the increase of concentration of greenhouse gases such as CO₂, the incident energy is greater than the escaping energy, leading to a temperature increase in the earth atmosphere, which is referred to as the greenhouse effect.

Carbon dioxide is the most important greenhouse gas, and the use of fossil fuels is a main discharge source thereof. The total CO₂ discharge in China has ranked No. 1 in the world. Moreover, the energy structure in China with coal as the main source will continue for a while, and coal energy will still be the foundation for peak shaving with new energy and for energy security. China has promised to the world that it will peak carbon emissions by 2030 and achieve carbon neutrality by 2060. The capture, storage, and utilization of CO₂ in flue gas play an important role in the control and reduction of greenhouse gas emission and in addressing the greenhouse effect and global warming issues.

At present, the mainstream carbon capture technology adopted is the amine method. Possible issues with amine method are high operating cost, and high discharge of wastes that is difficult to treat. New decarbonization technologies have been actively studied both in China and in other countries. Compared with the amine method, the ammonia method provides easy regeneration and low operating cost, and a decarbonization byproduct is ammonium bicarbonate fertilizer. Alternatively, part of the decarbonization circulating fluid may be regenerated to obtain CO₂, which can be used for the production of downstream products such as urea, soda ash, polycarbonate, etc., and for enhanced oil recovery, beverage production, and welding, and injected back directly underground or into oceans. Ammonium bicarbonate is a typical compound multi-nutrient fertilizer that can provide nitrogen and CO₂ to plants at the same time, which is particularly suitable for modern agriculture with soilless culture and plant growth in a greenhouse, providing CO₂ reclamation and carbon recycling, and avoiding potential secondary pollution and environmental accidents caused by underground carbon storage. Compared with decarbonization using the amine method, ammonia provides high CO₂ absorption efficiency, and the decarbonization product, ammonium bicarbonate, is easier to regenerate, which greatly lower the decarbonization cost.

However, ammonia is volatile, and decarbonization needs to take place under alkaline conditions, which increases ammonia slip (ammonia or one or more ammonia/amine bearing species that are derived from ammonia or ammonia/amine bearing species that were added to the gas flow, and that escape with the exhaust of the gas flow). Without solving these problems, ammonia slip may lead to higher decarbonization cost and secondary pollution.

Patent CN104707451A discloses a method for ammonia-based carbon capture and chemical synthesis from flue gas, which is implemented in a flue gas absorption and synthesis apparatus. The flue gas absorption and synthesis apparatus has a flue gas pipeline, an absorbing tower and a carbonization tower that are connected in parallel, an ammonia removing tower, and a solid-liquid separating device. Ammonia is used as an absorbing agent to capture CO₂ in the flue gas, sodium sulfate is used as a transforming medium to produce chemical products such as sodium carbonate and sodium bicarbonate. For the ammonia-containing tail gas after decarbonization, a simple water washing method is used to remove ammonia, which leads to large ammonia slip.

CN201110039363.2 discloses a system and a process of using an ammonia-based process to capture and absorb sulfur dioxide and carbon dioxide under normal pressure, wherein desulfurization is performed first, followed by decarbonization, and a plurality of heat exchangers are provided in the desulfurization and decarbonization units to control the absorption temperature. At the same time, concentrated aqueous ammonia is used first for desulfurization and decarbonization, and dilute aqueous ammonia is then used for desulfurization and decarbonization. After the decarbonization, the gas is discharged directly. Absorption using ammonia at only low temperature and low concentration cannot satisfactorily reduce ammonia slip. In addition, aqueous ammonia of low concentration bring in a large amount of water, which inhibits the crystallization of ammonium sulfate and ammonium bicarbonate.

CN104874272A discloses an apparatus and a method of integrated desulfurization and carbon dioxide capture, wherein the SO₂ in the flue gas is removed first in an ammonia desulfurization device, and then the flue gas is cooled in a direct contact cooling device before entering a decarbonization tower. After the decarbonization, the gas enters an ammonia washing tower that uses water for washing. After the washing, the flue gas enters a direct contact heating device, where some ammonia is removed in the spraying contact heating process. The aqueous solution discharged from the direct contact cooling tower is used as the spraying contact solution, and the solution after the direct contact spraying is cooled by the cooling tower and used for direct contact cooling spraying. The ammonia solution in the water washing tower enters the decarbonization tower for decarbonization or enters a stripping tower for ammonia removal. An acidic reagent, sulfuric acid, is added in the regeneration contact tower to enhance the ammonia washing. This method may have the following problems. Returning the water after direct water washing to decarbonization adds a lot of water into the decarbonization system, increasing the capital and operating cost. Further washing of ammonia consumes sulfuric acid. The process requires separate arrangements of a contact cooling device and a contact re-heating device, which leads to high capital and operating costs.

Therefore, it may be desirable to provide technology having features such as:

1. Good washing efficiency that is achieved by the use of acidic desulfurization absorbing fluid to wash ammonia-containing process gas;

2. The use of desulfurization circulating fluid to remove ammonia in the process gas after decarbonization and the direct use of the desulfurization circulating fluid after the washing for desulfurization, simplifying the process and realizing integrated desulfurization and decarbonization;

3. After ammonia washing, the direct use of ammonia-containing washing water as makeup water for desulfurization particulate scrubbing, to reduce desulfurization makeup water;

4. No need to separately provide a contact cooling device, which simplifies the process;

5. Condensate water that is circulated for use after membrane separation and purification, eliminating wastewater discharge;

6. Ammonium sulfate and ammonium bicarbonate fertilizers that are recovered, and decarbonization circulating fluid that may be regenerated, partially or wholly, to obtain Co₂. The Co₂ can be used for beverage production, enhanced oil recovery, welding, and the production of urea, soda ash, sodium bicarbonate, polycarbonate, polyurethane, food-grade CO₂, CO₂ gas fertilizer, potassium bicarbonate, and the like, which eliminates the need to inject all the Co₂ back to underground for sequestration, truly realizing carbon emission reduction; and

7. Eliminating a need to control SO₂ concentration at the outlet of a desulfurization functional area to be ≤2 ppm and removing sulfur oxides that are not removed in the desulfurization functional area in a decarbonization apparatus, lowering capital and operating cost of a desulfurization apparatus.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is an illustrative block flow diagram in relation to an apparatus in accordance with the principles of the invention.

FIG. 2 shows schematically apparatus in accordance with the principles of the invention.

FIG. 3 shows schematically apparatus in accordance with the principles of the invention.

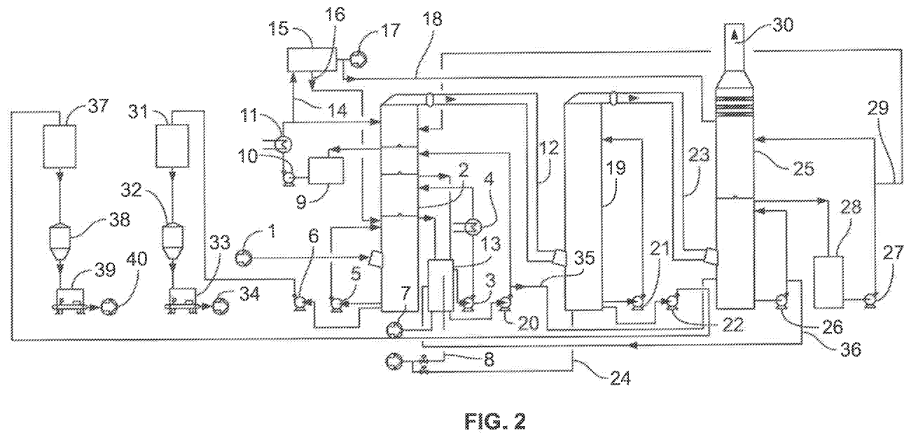

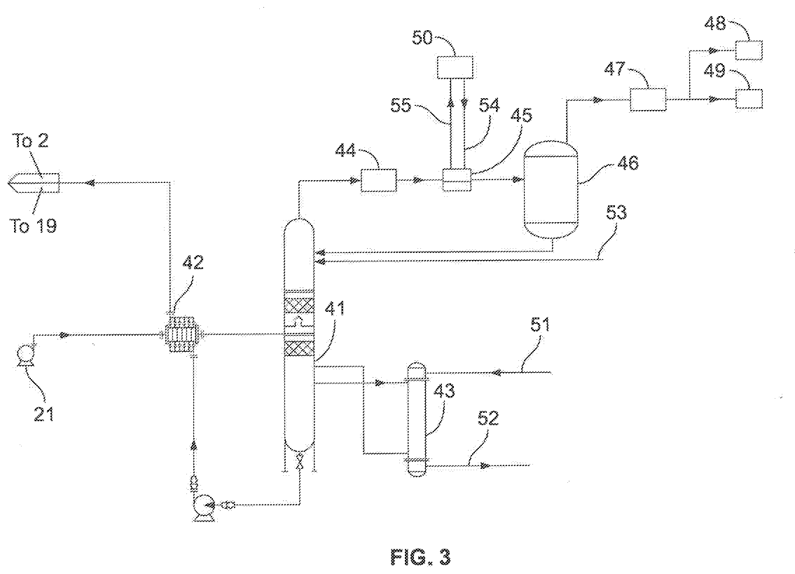

In FIG. 2 and FIG. 3, the reference numerals have the following meanings:
1. process gas;
2. desulfurization tower;
3. desulfurization circulating pump;
4. desulfurization heat exchanger;
5. desulfurization circulating pump;
6. ammonium sulfate discharge pump;
7. oxidation air;
8. going to the desulfurization system for ammonia addition;
9. desulfurization circulating water tank;
10. desulfurization circulating pump;
11. desulfurization heat exchanger;
12. post-desulfurization tail gas;
13. desulfurization circulating tank;
14. flue gas condensate;
15. membrane separation apparatus;
16. concentrated solution from membrane separation;
17. externally discharged purified water from membrane separation;
18. purified water going to an ammonia washing functional area;
19. decarbonization tower;
20. particulate washing circulating pump;
21. circulating pump for the decarbonization tower;
22. discharge pump for the decarbonization tower;
23. post-decarbonization tail gas;
24. going to the decarbonization system for ammonia addition;
25. ammonia washing tower;
26. circulating pump for the ammonia washing functional area;
27. circulating pump for the ammonia washing functional area;
28. ammonia washing water tank;
29. ammonia washing water drainage;
30. clean flue gas;
31. ammonium sulfate solid-liquid separator;
32. ammonium sulfate drier;
33. ammonium sulfate packing machine;
34. ammonium sulfate product;
35. acidic desulfurization fluid;
36. returned desulfurization fluid;
37. ammonium bicarbonate solid-liquid separator;
38. ammonium bicarbonate drier;
39. ammonium bicarbonate packing machine;
40. ammonium bicarbonate product;
41. CO₂ regeneration tower;
42. solution heat exchanger;
43. reboiler;
44. circulating water cooler;
45. chilled water cooler;
46. CO₂ buffer tank;
47. CO₂ compressor;
48. loading into bottles or tanker;
49. CO₂ downstream production apparatus;
50. heat pump system;
51. steam;
52. condensate;
53. process water;
54. chilled water supply;
55. chilled water return.

### DETAILED DESCRIPTION

Apparatus and methods for ammonia-based desulfurization and decarbonization are provided. The apparatus and methods may use ammonia to remove sulfur oxides and CO₂ to produce ammonium sulfate and ammonium bicarbonate fertilizers. The apparatus may include one or more of an ammonia-based desulfurization functional area, an ammonia-based decarbonization functional area, an ammonia washing functional area, an ammonium sulfate post-processing system, and an ammonium bicarbonate post-processing system. Ammonia may be used as a desulfurizing agent and a decarbonizing agent. A gas may first enter the desulfurization functional area for desulfurization to produce ammonium sulfate fertilizer. At least part of the desulfurization may be performed in a tower associated with the desulfurization functional area. The desulfurized gas may enter the decarbonization functional area for removal of carbon dioxide for the production of ammonium bicarbonate fertilizer. At least part of the decarbonization may be performed in a tower associated with the decarbonization functional area. The decarbonized gas may include free ammonia. The decarbonized gas may enter the ammonia washing functional area for washing with an ammonium sulfate solution for desulfurization, and then with water. At least part of the washing may be performed in a tower associated with the ammonia washing functional area. After the washing, the ammonia-containing ammonium sulfate solution and aqueous solution may be returned to the desulfurization functional area, where they may serve as an absorbing agent for desulfurization. The above functional areas may be combined in one tower or more than one tower. The above functional areas may be disposed in one tower or more than one tower. The above functional areas may include towers, such as a desulfurization tower associated with the desulfurization functional area, a decarbonization tower associated with the decarbonization functional area, and an ammonia washing tower associated with the ammonia washing functional area. The desulfurization functional area may be divided into a plurality of segments. The segments may include one or more of a cooling and concentrating segment, an absorbing segment, and a particulate removing segment. Each segment may be provided with at least one spraying layer. A device/part may be arranged between segments to allow a gas to pass. The particulate removing segment may be divided into two parts: for spray washing in the first part, an ammonium sulfate-containing concentrated solution may be used for circulated washing. An ammonium sulfate-containing dilute solution may be used in the second part for circulated washing. A device/part may be arranged between the two parts to allow a gas to pass. The concentration of the concentrated ammonium sulfate solution in the first part may be controlled at 5-40%, preferably 10-30%, and the pH may be controlled at 3-7, preferably 3-5.5. The concentration of the dilute ammonium sulfate solution in the second part may be controlled at 0.02-10%, preferably 0.03-5%, and the pH may be controlled at 3-7.

An ammonia-based desulfurization and decarbonization method may include the following steps, which may be performed in the order below:

1) using a desulfurization circulating fluid to remove part of SO₂ in the process gas;

2) using a decarbonization circulating fluid to remove part of CO₂ in the process gas; and

3) using a desulfurization circulating fluid to remove part of free ammonia in the process gas, and returning the desulfurization circulating fluid to a desulfurization apparatus.

Step 1) and step 2) may be followed by production of ammonium sulfate and ammonium bicarbonate fertilizers.

The CO₂ removal efficiency in step 2) may be in the range 30-98%.

Part of the decarbonization circulating fluid may be sent to an ammonium bicarbonate post-processing apparatus to produce ammonium bicarbonate fertilizer, and/or part of the decarbonization circulating fluid may be sent to a CO₂ regeneration apparatus to obtain gaseous CO₂. The CO₂ regeneration apparatus may include a regeneration tower. Part of the CO₂ may be used for one or more of beverage production, enhanced oil recovery, and welding. Part of the CO₂ may be used for production of one or more downstream products including urea, soda ash, sodium bicarbonate, polycarbonate, polyurethane, food-grade CO₂, CO₂ gas fertilizer, potassium bicarbonate, and the like.

The methods may include performing, between step 2) and step 3), a step 4) that may use process water to remove some or all of the free ammonia that may be present in the process gas. The methods may include performing, after step 3), a step 5) that may use process water to remove some or all of the free ammonia that may be present in the process gas.

The desulfurization circulating fluid may have a concentrated circulating fluid and an absorbing circulating fluid. The concentrated circulating fluid may have a pH of 1-6. The concentrated circulating fluid may have a pH of 2-4.5. The concentrated circulating fluid may have an ammonium sulfite concentration of 0-0.2%. The concentrated circulating fluid may have an ammonium sulfate concentration of 10-60%. The absorbing circulating fluid may have a pH of 4.5-6.5. The absorbing circulating fluid may have a pH of 4.8-6.2. The absorbing circulating fluid may have an ammonium sulfite concentration of 0.1-3%. The absorbing circulating fluid may have an ammonium sulfate concentration of 10-38%.

The decarbonization circulating fluid may have a pH of 7-13. The decarbonization circulating fluid may have a pH of 7.5-11. The decarbonization circulating fluid may have a pH of 8-9.5. The decarbonization circulating fluid may have an ammonium bicarbonate concentration of 3-40%. The decarbonization circulating fluid may have an ammonium bicarbonate concentration of 10-22%. The decarbonization circulating fluid may have an NH₃/CO₂ molar ratio of 0.6-4. The decarbonization circulating fluid may have an NH₃/CO₂ molar ratio of 1.2-3. The decarbonization circulating fluid may have an NH₃/CO₂ molar ratio of 2-2.5.

The desulfurization absorption temperature may be in the range 5-55° C. The desulfurization absorption temperature may be in the range 15-50° C. The desulfurization absorption temperature may be in the range 20-40° C. The decarbonization absorption temperature may be in the range 0-45° C. The decarbonization absorption temperature may be in the range 5-40° C. The decarbonization absorption temperature may be in the range 10-30° C. A heat pump refrigeration technology may be used to provide cooling for cooling the decarbonization circulating fluid and the desulfurization circulating fluid. The temperature of the chilled water obtained by the heat pump may be in the range 3-25° C. The temperature of the chilled water obtained by the heat pump may be in the range 5-10° C.

Power for the heat pump may include one or more of hot water, steam, and electricity. Circulating water or desalted water may be used as a cold source. When desalted water is used, the desalted water after heat exchange may be sent to a low-temperature coal economizer to lower coal consumption per ton of steam.

The desulfurization functional area may be provided with a cooling apparatus to control the temperature of desulfurized flue gas in the range 5-55° C. The range may be 20-40° C. The ranges may meet temperature requirements for subsequent decarbonization. The cooling apparatus may be arranged on the circulating pipeline for the desulfurization circulating fluid to cool the desulfurization circulating fluid. After the cooling, the cooled desulfurization circulating fluid may further cool the desulfurized flue gas. A plurality of cooling apparatus may be provided, for example, on the circulating and absorbing pipeline in the absorbing segment and the particulate removing segment. Cooling apparatus may be provided on the water washing pipeline in the particulate removing segment. The washing condensate may be purified through membrane separation. The concentrated solution may enter the desulfurization absorbing area. The clean water may be used as makeup water for ammonia washing or may be used externally.

The cooling apparatus may be arranged in the process gas pipeline, at the inlet, inside of, or at the outlet of the desulfurization functional area. The circulating water or chilled water may be used as a cooling agent, which may be used individually or may be combined. The desulfurization circulating solution for ammonia washing may be taken from the circulating washing solution of the desulfurization tower and, after the ammonia washing, may be returned to the ammonia-based desulfurization functional area for desulfurization. The pH of the ammonium sulfate washing solution may be controlled at 2.5-7.5. The pH of the ammonium sulfate washing solution may be controlled at 3-5.5.

The pH for washing the process water may be controlled at 3-7. Part of the water solution absorbed during the ammonia washing circulation may enter, as makeup water, the circulating fluid for the particulate removing segment of the desulfurization tower. The ammonium sulfate concentration in the circulating solution may be controlled at 0-5%. The ammonium sulfate concentration in the circulating solution may be controlled at 0.02-2%.

Part of the water washing circulating solution may be pumped out and sent to a purification membrane separation apparatus. The produced purified water may be used as makeup water for the desulfurization and washing functional areas to control the ammonia concentration in the washing water and the concentration of the dilute ammonium sulfate solution for desulfurization and washing. The concentrated solution may enter the desulfurization absorption area.

The decarbonization functional area and the ammonia washing functional area may include one or a combination of a sprayer, a plate, and packed and floating-valve absorption columns.

The ammonium sulfate slurry produced from desulfurization may enter an ammonium sulfate post-processing system. After solid-liquid separation, wet ammonium sulfate may be dried and packed into an ammonium sulfate product. A wet ammonium sulfate product may be output directly. Solution from the solid-liquid separator may be returned to the desulfurization functional area. If an ammonium sulfate solution is produced, the solution may be evaporated and crystallized to form an ammonium sulfate slurry before entering the solid-liquid separation apparatus.

The ammonium bicarbonate slurry produced from the decarbonization tower may enter the solid-liquid separation apparatus. The solution may be returned to the decarbonization functional area. The wet ammonium bicarbonate may be dried and packed into a product. A wet ammonium bicarbonate product may be output directly. Part of the ammonium bicarbonate produced from the decarbonization may be heated to produce CO₂ and an ammonia solution. The ammonia-containing solution may be returned to the decarbonization functional area for further use.

Main parameters of the desulfurization functional area may include:
Empty tower gas velocity controlled at 0.5-5 m/s
Empty tower gas velocity controlled at 2-4 m/s
Circulating fluid spraying density of each layer at 4-100 m³/m²·h
Circulating fluid spraying density of each layer at 8-80 m³/m²·h
Circulating fluid temperature controlled at 5-55° C.
Circulating fluid temperature controlled at 20-40° C.
Circulating fluid pH controlled at 1-7

Main parameters of the decarbonization functional area may include:
Empty tower gas velocity controlled at 0.1-5 m/s
Temperature controlled at 5-40° C.
Temperature controlled at 10-30° C.
Circulating fluid pH controlled at 7-11

Main parameters of the ammonia washing functional area may include:
Empty tower gas velocity controlled at 0.25-5 m/s
Temperature controlled at 0-50° C.
Temperature controlled at 3-40° C.
Circulating fluid pH controlled at 3-10

A strong acid, such as sulfuric acid, nitric acid, or hydrochloric acid, may be added into the desulfurization functional area and/or the ammonia washing functional area to adjust the pH of the circulating fluid.

The apparatus may include a heat pump system. Heat pump refrigeration technology may be used to provide cooling capacity for cooling the decarbonization circulating fluid and the desulfurization circulating fluid. The temperature of the chilled water obtained by the heat pump may be in the range 3-25° C. The temperature of the chilled water obtained by the heat pump may be in the range 5-10° C. The chilled water inlet/return pipelines may be connected with some or all chilling heat exchangers.

The apparatus may include a CO₂ regeneration tower in which regeneration of decarbonization circulating fluid proceeds. CO₂ regeneration tower operating parameters may include:
At tower bottom, a regeneration temperature in the range 90-150° C.
At tower bottom, a regeneration temperature in the range 100-130° C.
At tower top, a regeneration temperature in the range 6-100° C.
At tower top, a regeneration temperature in the range 70-90° C.
At tower bottom, a regeneration pressure in the range 0.2-0.7 MPa
At tower bottom, a regeneration pressure in the range 0.3-0.5 MPa
A regeneration tower gas velocity in the range 0.2-3 m/s
A regeneration tower gas velocity in the range 0.3-2 m/s

The apparatus may include one or more of a solution heat exchanger, a reboiler, a circulating water cooler, a chilled water cooler, a CO₂ buffer tank, and a CO₂ compressor.

The circulating pump for the decarbonization tower may output a part of the decarbonization circulating solution to a solution heat exchanger for heat exchange. The solution may then enter the CO₂ regeneration tower. After the tower bottom is heated by steam from the reboiler, CO₂ gas may be collected at the top of the tower. The gas may be subjected to two-stage cooling by the circulating water cooler and the chilled water cooler. The gas may then be sent to the CO₂ buffer tank. After a certain period of buffering, the gas may be sent out for compression by the CO₂ compressor. Condensate may be taken out from the bottom of the reboiler.

Process water may be added to an upper part of the CO₂ regeneration tower.

After the CO₂ obtained from regeneration is subjected to gas-liquid separation, part of the gas may be used for production of downstream products or enhanced oil recovery. The downstream products may include one or more of urea, soda ash, sodium bicarbonate, polycarbonate, food-grade CO₂, CO₂ gas fertilizer, potassium bicarbonate, and the like. Part of the gas may be used for one or more of enhanced oil recovery, beverage production, and welding. Part of the gas may be used for marine sequestration or underground sequestration. Separation liquid from the gas-liquid separation may be returned to the CO₂ regeneration tower.

The apparatus and methods may include interaction between decarbonization and desulfurization processes. The apparatus and methods may include using an acidic desulfurization circulating fluid to wash ammonia. This may help achieve a high ammonia washing efficiency, and may reduce or eliminate ammonia slip during the decarbonization process. Ammonium bicarbonate output, the amount of sequestered CO₂, and the output of CO₂ downstream products may be flexibly adjusted.

By-product ammonia may be used in the process, thereby realizing treating wastes with wastes and a circular economy. Comparison between (a) the apparatus and methods; and (b) the calcium-based desulfurization/sodium-based desulfurization method+amine-based decarbonization+carbon sequestration device (also referred to as the “other approaches”):
The apparatus and methods, relative to the other approaches, may occupy a smaller land area and may flexibly adjust the amount of sequestered CO₂;
The apparatus and methods may more flexibly adjust the output of byproducts
In the apparatus and methods, unlike in the other approaches, CO₂ may be used for production of urea, sodium bicarbonate, soda ash, food-grade CO₂, polycarbonate, methanol, synthesis gas, and polyurethane, and used for enhanced oil recovery, welding, gas fertilizer, and the like. The total demand in China is close to 150 million ton/year;
Decarbonization with amines after calcium-based desulfurization may require the provision of an alkaline deep desulfurization device, and the decarbonization capital cost may be increased by 60-80% over that of the existing desulfurization device. The capital cost for ammonia-based desulfurization may be about 85-95% of the calcium-based desulfurization, and the capital cost for ammonia-based decarbonization may be about 60% of amine-based decarbonization. Integrated desulfurization and decarbonization may further reduce the capital cost by about 10-20%. Therefore, the capital cost of the integrated desulfurization and decarbonization technology may be 40-50% lower than that for the calcium-based desulfurization+sodium-based desulfurization+amine-based decarbonization. Moreover, it does not generate any wastewater or waste residues.

The operating cost of the integrated desulfurization and decarbonization technology may be 50-60% lower than those of the calcium-based desulfurization+alkaline desulfurization+amine-based decarbonization.

Comparison between (a) ammonia-based desulfurization and decarbonization technology and (b) the calcium-based desulfurization+alkaline desulfurization+amine-based decarbonization technology

| | Calcium-based desulfurization + | |
|---|---|---|
| | alkaline washing + amine-based | Integrated ammonia-based |
| Technology | decarbonization | desulfurization and decarbonization |
| Raw materials for | Limestone powder CaCO3/liquid | Anhydrous ammonia or aqueous |
| desulfurization and | caustic soda + ethanolamine | ammonia |
| decarbonization | | |
| Byproducts of | Gypsum (solid waste)/waste alkali | Ammonium sulfate + ammonium |
| desulfurization and | | bicarbonate (sold as fertilizers) |
| decarbonization | | |
| Wastewater | Yes, about 0.35 t/104 kw | No |
| Waste residues | Yes | No |
| Waste gas | Production of CO₂ from desulfurization | No |
| | at 0.7 t/tSO₂ | |
| Capital cost | 1A | 0.5-0.6A |
| Operating cost | 1B-2B | 0.4-0.5B |
| Land area | Large | Small |
| Supporting | High, requiring the marine or deep | Low, and the product structure can be |
| requirements | geological structure layer for carbon | flexibly adjusted |
| | sequestration | |

Technical metrics of the apparatus and methods may include:
Decarbonization efficiency not lower than 50%, and the content of CO₂ (including fine particulates) in the flue gas at the outlet of the decarbonization tower controlled at ≤6% by volume
SO₂ content at the outlet ≤5 mg/Nm³
Ammonia recovery (fraction or percentage of ammonia added to a gas cleaning process that is subsequently captured and extracted from the process) ≥98%, and ammonia slip at the decarbonization outlet ≤10 ppm
Power consumption ≤250 kW·h/t CO₂
Steam consumption ≤1.2 t/t CO₂

Apparatus and methods for ammonia-based desulfurization and decarbonization are provided. The ammonia may be used to remove sulfur oxides and CO₂ in process gas. The process gas may be fed into a desulfurization apparatus.

The methods may include (1) removing, using desulfurization circulating fluid, SO₂ from the process gas. The methods may include (2) removing, using a decarbonization circulating fluid, CO₂ from the process gas. The methods may include (3) removing, using desulfurization circulating fluid, free ammonia from the process gas. The methods may include returning the desulfurization circulating fluid to a desulfurization apparatus. The methods may include performing two or more of the aforementioned steps in the order presented.

The methods may include producing fertilizer. The fertilizer may include ammonium sulfate. The fertilizer may include ammonium bicarbonate.

The removing of CO₂ may be performed such that a CO₂ removal efficiency from 30-98% is achieved.

The methods may include producing from the decarbonization circulating fluid ammonium bicarbonate fertilizer. The methods may include regenerating gaseous CO₂ from the decarbonization circulating fluid. The regenerating may be performed in a regeneration system that includes a CO₂ regeneration tower having a tower bottom and a tower top.

An operating temperature at the tower bottom may be in a range from 90-150° C. The range may be from 100-130° C.

An operating temperature at the tower top may be in a range from 6-100° C. The range may be from 70-90° C.

A regeneration pressure at the tower bottom may be in a range from 0.2-0.7 MPa. The range may be from 0.3-0.5 MPa.

The methods may include flowing gas in the tower at a gas velocity in a range from 0.2-3 m/s. The range may be from 0.3-2 m/s.

The methods may include producing from the decarbonization circulating fluid ammonium bicarbonate fertilizer. The methods may include producing, from gaseous CO₂ removed from the process gas, a downstream product.

The downstream product may include urea. The downstream product may include soda ash. The downstream product may include sodium bicarbonate. The downstream product may include polycarbonate. The downstream product may include CO₂ gas fertilizer. The downstream product may include potassium bicarbonate. The downstream product may include food-grade CO₂.

The methods may include enhanced oil recovery, with gaseous CO₂ removed from the process gas.

The methods may include sequestering gaseous CO₂ removed from the process gas. The sequestering may include performing marine sequestration. The sequestering may include performing underground sequestration.

The methods may include, between step 2 and step 3, removing, using process water, free ammonia from the process gas. The methods may include, after step 3, removing, using process water, free ammonia from the process gas.

The desulfurization circulating fluid may include a concentrated circulating fluid. The desulfurization circulating fluid may include an absorbing circulating fluid. The concentrated circulating fluid may have ammonium sulfite at a concentration of 0-0.2%. The concentrated circulating fluid may have ammonium sulfate at a concentration of 10-60%. The absorbing circulating fluid may have ammonium sulfite at a concentration of 0.1-3%. The absorbing circulating fluid may have ammonium sulfate at a concentration of 10-38%.

The concentrated circulating fluid may have a pH of 1-6. The concentrated circulating fluid may have a pH of 2-4.5.

The absorbing circulating fluid may have a pH of 4.5-6.5. The absorbing circulating fluid may have a pH of 4.8-6.2.

The decarbonization circulating fluid may have a pH of 7-13. The decarbonization circulating fluid may have a pH of 7.5-11. The decarbonization circulating fluid may have a pH of 8-9.5.

The decarbonization circulating fluid may have ammonium bicarbonate at a concentration of 340%. The decarbonization circulating fluid may have ammonium bicarbonate at a concentration of 10-22%.

The decarbonization circulating fluid may have an NH₃/CO₂ molar ratio of 0.6-4. The decarbonization circulating fluid may have an NH₃/CO₂ molar ratio of 1.2-3. The decarbonization circulating fluid may have an NH₃/CO₂ molar ratio of 2-2.5.

The desulfurization may include absorbing SO₂ at a temperature in a range from 5-55° C. The desulfurization may include absorbing SO₂ at a temperature in a range from 15-50° C. The desulfurization may include absorbing SO₂ at a temperature in a range from 20-40° C.

The decarbonization may include absorbing CO₂ at a temperature in a range from 0-45° C. The decarbonization may include absorbing CO₂ at a temperature in a range from 5-40° C. The decarbonization may include absorbing CO₂ at a temperature in a range from 10-30° C.

The apparatus may be configured to perform one or more steps of the methods.

The apparatus may include an ammonia-based desulfurization functional area that may be configured to apply a desulfurizing agent to a process gas. The desulfurization functional area may include a desulfurization tower. The apparatus may include an ammonia-based decarbonization functional area that may be configured to apply a decarbonizing agent to the process gas. The decarbonization functional area may include a decarbonization tower. The apparatus may include an ammonia washing functional area. The ammonia washing functional area may include an ammonia washing tower. The apparatus may include an ammonium sulfate post-processing system. The apparatus may include an ammonium bicarbonate post-processing system.

The desulfurizing agent may include ammonium. The decarbonizing agent may include ammonium. The desulfurization functional area may be configured to receive the process gas. The desulfurization functional area may be configured to desulfurize the process gas. The decarbonization functional area may be configured to receive the process gas after the process gas exits the desulfurization functional area. The decarbonization functional area may be configured to remove carbon dioxide from the process gas. The decarbonization functional area may be configured to produce an ammonium bicarbonate-containing material. The material may include a solution. The material may include a slurry. The ammonia washing functional area may be configured to receive process gas after the process gas exits the decarbonization functional area. The ammonia washing functional area may be configured to wash the process gas with a desulfurization circulating fluid. The ammonia washing functional area may be configured to wash the process gas with process water. The ammonia washing functional area may be configured to wash the process gas with process water after the ammonia washing functional area washes the process gas with a desulfurization circulating fluid. The ammonia washing functional area may be configured to wash the process gas with a desulfurization circulating fluid after the ammonia washing functional area washes the process gas with process water.

The desulfurization functional area may be configured to receive the process gas after the process gas exits the ammonia washing functional area. The desulfurization functional area may be configured to receive the process water after the process water exits the ammonia washing functional area. The desulfurization functional area may be configured to spray the process gas and the process water as an absorbing agent for desulfurization. The desulfurization functional area may be configured to receive ammonium sulfate-containing ammonium bicarbonate solution after the ammonium bicarbonate solution exits the decarbonization functional area.

The ammonia washing functional area may be configured to wash the process gas with the process water before washing the process gas with the desulfurization circulating fluid.

The ammonia-based desulfurization functional area, the ammonia-based decarbonization functional area, and the ammonia washing functional area may be disposed in a tower.

The desulfurization functional area may include a cooling and concentrating segment that may include a first spraying layer. The desulfurization functional area may include an absorbing segment. The absorbing segment may include a second spraying layer. The absorbing segment may be in fluid communication with the cooling and concentrating segment via a first device. The first device may be configured to allow gas to pass. The desulfurization functional area may include a particulate removing segment. The particulate removing segment may be in fluid communication with the absorbing segment via a second device. The second device may be configured to allow gas to pass. Each of the segments may include at least one spraying layer. Each of the segments may include a device that may be configured to allow gas to pass between the segments.

The apparatus may include, in the particulate removing segment, a first washing part configured to wash with concentrated, circulating ammonium sulfate-containing solution. The apparatus may include, in the particulate removing segment, a second washing part. The second washing part may be configured to wash with dilute, circulating ammonium sulfate-containing solution. The second washing part may be in fluid communication with the first washing part via a device that allows gas to pass.

The first part may be configured to maintain an ammonium sulfate concentration of the concentrated ammonium sulfate-containing solution in a range that is 10-38%. The first part may be configured to maintain an ammonium sulfate concentration of the concentrated ammonium sulfate-containing solution in a range that 12-30%. The first part may be configured to maintain a pH of the concentrated ammonium sulfate-containing solution in a range that is 2.5-7.5. The first part may be configured to maintain a pH of the concentrated ammonium sulfate-containing solution in a range that is 3-5.5.

The second part may be configured to maintain an ammonium sulfate concentration of the dilute ammonium sulfate-containing solution in a range that is 0-5%. The second part may be configured to maintain an ammonium sulfate concentration of the dilute ammonium sulfate-containing solution in a range that is 0.02-2%. The second part may be configured to maintain a pH of the dilute ammonium sulfate-containing solution in a range that is 3-7.

The desulfurization functional area may include a cooling apparatus. The cooling apparatus may be configured to maintain a temperature of process gas in a range that is 5-55° C. The range may be 15-50° C. The range may be 20-40° C.

The decarbonization functional area may include a cooling apparatus. The cooling apparatus may be configured to maintain a temperature of process gas in a range that is 0-45° C. The range may be 5-40° C. The range may be 10-30° C.

The apparatus may include a circulating pipeline. The circulating pipeline may be configured to transport desulfurization circulating fluid. The cooling apparatus may be arranged on the circulating pipeline. The cooling apparatus may be configured to cool spraying fluid. The cooling apparatus may be configured to cool circulating desulfurization fluid. The cooling apparatus may be configured to cool the process gas. The cooling apparatus may be configured to circulate water as a coolant.

The apparatus may include a process gas conduit. The cooling apparatus may be arranged on the process gas conduit. The cooling apparatus may be configured to cool the process gas.

The ammonia washing functional area may be configured to receive desulfurization fluid from the ammonia-based desulfurization functional area. The ammonia washing functional area may be configured to, using the desulfurization fluid, absorb ammonia from post-decarbonization process gas. The ammonia washing functional area may be configured to, after absorbing the ammonia, return the desulfurization fluid to the desulfurization functional area. The ammonia washing functional area may be configured to collect aqueous solution during ammonia washing. The ammonia washing functional area may be configured to provide the aqueous solution to the desulfurization functional area. The desulfurization functional area may be configured to use the returned desulfurization fluid to desulfurize the process gas. The desulfurization functional area may be configured to use the provided aqueous solution for particle removal. A pH of ammonium sulfate washing solution may be controlled at 2.5-7.5. The pH may be a pH of the solution in a washing part of the particulate removing segment. The washing part may be a first washing part. For example, the pH may be a pH of the solution in a desulfurization circulating tank of the desulfurization functional area, a washing circulating pump of the particulate removing segment of the desulfurization functional area, or any other suitable location.

An ammonia concentration in an ammonia washing circulating solution in the ammonia washing functional area may be controlled at 0-5%. An ammonia concentration in an ammonia washing circulating solution in the ammonia washing functional area may be controlled at 0-1%.

The apparatus may include a purification membrane separation apparatus. The apparatus may include a conduit. The particulate removing segment may be configured to provide dilute ammonium sulfate solution. The purification membrane separation apparatus may be configured to receive the dilute ammonium sulfate solution. The purification membrane separation apparatus may be configured to produce purified water from the dilute ammonium sulfate solution. The conduit may be configured to convey a fraction of the purified water to the ammonia washing functional area.

The ammonia washing functional area may be configured to use the purified water to replenish circulating washing water in the ammonia washing functional area.

The ammonia washing functional area may be configured to use the purified water to control a concentration of ammonia in the washing water.

The ammonia washing functional area may be configured to use the purified water to control a concentration of ammonium sulfate solution for return to the desulfurization functional area.

The conduit may include a first conduit. The fraction may include a first fraction. The apparatus may include a second conduit. The second conduit may be configured to convey concentrated solution to a desulfurization absorption area of the desulfurization functional area.

The apparatus may include an ammonium bicarbonate post-processing system. The decarbonization functional area may be configured to produce an ammonium bicarbonate slurry. The ammonium bicarbonate post-processing system may be configured to remove solution from the slurry. The ammonium bicarbonate post-processing system may be configured to pack the slurry into a product. The ammonium bicarbonate post-processing system may be configured to return the solution to the decarbonization functional area.

The apparatus may include a CO₂ regeneration system. The CO₂ regeneration system may be configured to heat ammonium bicarbonate from the decarbonization functional area to produce CO₂. The CO₂ regeneration system may be configured to heat ammonium bicarbonate from the decarbonization functional area to produce an ammonia solution. The CO₂ regeneration system may be configured to provide the ammonia solution to the decarbonization functional area.

The ammonia-based desulfurization functional area may be configured to control a gas velocity at 0.5-5 m/s. The ammonia-based desulfurization functional area may be configured to control a gas velocity at 2-4 m/s. The ammonia-based desulfurization functional area may be configured to control a circulating fluid spraying density for a spray layer at 4-100 m³/m²-h. The ammonia-based desulfurization functional area may be configured to control a circulating fluid spraying density for a spray layer at 8-80 m³/m²-h. The ammonia-based desulfurization functional area may be configured to control a circulating fluid temperature at 5-55° C. The ammonia-based desulfurization functional area may be configured to control a circulating fluid temperature at 20-40° C. The ammonia-based desulfurization functional area may be configured to control a circulating fluid pH at 1-7. The gas velocity may be an empty tower gas velocity.

The ammonia-based decarbonization functional area may be configured to control a gas velocity at 2-4 m/s. The ammonia-based decarbonization functional area may be configured to control a gas temperature at 5-40° C. The ammonia-based decarbonization functional area may be configured to control a gas temperature at 10-30° C. The ammonia-based decarbonization functional area may be configured to control circulating fluid pH at 7-11. The gas velocity may be an empty tower gas velocity.

The ammonia washing functional area may be configured to control a velocity at 0.25-5 m/s. The ammonia washing functional area may be configured to control a gas temperature at 0-50° C. The ammonia washing functional area may be configured to control a temperature at 3-40° C. The ammonia washing functional area may be configured to control a circulating fluid pH at 3-10.

The apparatus may include a heat pump system. The heat pump system may be configured to receive water, at a temperature from 3-25° C., from a chilled water cooler that may be in thermal communication with the CO₂. The heat pump system may be configured to receive water, at a temperature from 5-10° C., from a chilled water cooler that may be in thermal communication with the CO₂. The heat pump system may be configured to return the chilled water to the chilled water cooler.

The apparatus may include a CO₂ regeneration tower. The CO₂ regeneration tower may be configured to extract CO₂ from the process gas.

The CO₂ regeneration tower may be configured to maintain a temperature of the process gas at a bottom of the tower at 90-150° C. The CO₂ regeneration tower may be configured to maintain a temperature of the process gas at a bottom of the tower at 100-130° C.

The CO₂ regeneration tower may be configured to maintain a temperature of the process gas at atop of the tower at 6-100° C. The CO₂ regeneration tower may be configured to maintain a temperature of the process gas at a top of the tower at 70-90° C.

The CO₂ regeneration tower may be configured to maintain a pressure of the process gas at a bottom of the tower at 0.2-0.7 MPa. The CO₂ regeneration tower may be configured to maintain a pressure of the process gas at a bottom of the tower at 0.3-0.5 MPa.

The CO₂ regeneration tower may be configured to maintain a gas velocity in the tower at 0.2-3 m/s. The CO₂ regeneration tower may be configured to maintain a gas velocity in the tower at 0.3-2 m/s.

The apparatus may include a process water inlet. The inlet may be disposed on an upper part of the CO₂ regeneration tower.

The apparatus may include a solution heat exchanger. The apparatus may include a reboiler. The apparatus may include a circulating water cooler. The apparatus may include a chilled water cooler in fluid communication with the circulating water cooler. The apparatus may include a CO₂ buffer tank. The apparatus may include a CO₂ compressor.

The decarbonization circulating pump may provide a fraction of the bicarbonate-containing material, via the solution heat exchanger, to the CO₂ regeneration tower. The chilled water cooler may be configured to receive CO₂, via the circulating water cooler, from the top of the tower. The CO₂ compressor may be configured to receive CO₂, via the CO₂ buffer tank, from the chilled water cooler. The CO₂ compressor may be configured to compress the CO₂. The CO₂ compressor may be configured to discharge the CO₂.

The absorbing fluid and/or process gas may be cooled during desulfurization to prepare it for decarbonization. After the decarbonization, a desulfurization circulating fluid may be used for absorption of ammonia from the ammonia-containing process gas. After the absorption, the circulating fluid may be returned to a desulfurization functional area for desulfurization, thereby reducing the amount of ammonia added for desulfurization. After the decarbonization, fresh water may be used to wash the gas. Resultant ammonia-containing washing water may be returned, after the washing, to the desulfurization functional area to replenish washing water that is used to remove desulfurized particulates. Condensate produced from the particulate removing segment may be purified through membrane separation. Clean water may be used as makeup water for ammonia washing. Excess water may be discharged from the apparatus for external use.

Illustrative embodiments of apparatus and methods in accordance with the principles of the invention will now be described with reference to the accompanying drawings, which forma part hereof. It is to be understood that other embodiments may be utilized and that structural, functional and procedural modifications, additions or omissions may be made, and features of illustrative embodiments, whether apparatus or method, may be combined, without departing from the scope and spirit of the present invention.

All ranges and parameters disclosed herein shall be understood to encompass any and all subranges subsumed therein, every number between the endpoints, and the endpoints.

For example, a stated range of “1 to 10” should be considered to include any and all subranges between (and inclusive of) the minimum value of 1 and the maximum value of 10; that is, all subranges beginning with a minimum value of 1 or more (e.g. 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

Unless stated otherwise, %-concentrations are volume percentages for gas and weight percentages for liquid.

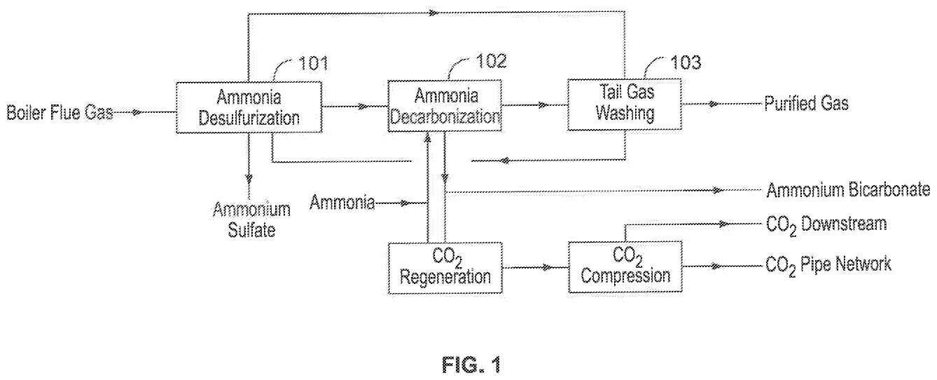

FIG. 1: shows an illustrative schema for ammonia-based desulfurization, ammonia-based decarbonization and tail gas washing. Boiler flue gas may enter desulfurization functional area 101 that comprises an ammonia-based desulfurization system. Output from the ammonia-based desulfurization system may enter decarbonization functional area 102 that comprises an ammonia-based decarbonization system. Output from the ammonia-based decarbonization system may enter ammonia washing functional area 103 that comprises a tail gas washing system. The tail gas washing system may provide purified gas.

The ammonia-based desulfurization system may provide liquid that is sent to the tail gas washing system. The tail gas washing system may provide liquid that is sent to the ammonia-based desulfurization system.

The ammonia-based desulfurization system may provide ammonium sulfate.

The ammonia-based decarbonization system may exchange material with a CO₂ regeneration system. The ammonia-based decarbonization system may provide ammonium bicarbonate.

The CO₂ regeneration system may provide CO₂ to a CO₂ compressor. The CO₂ compressor may provide CO₂ to downstream products or processes. The CO₂ compressor may provide CO₂ to a pipe network.

FIG. 2 and FIG. 3 show schematically ammonia-based desulfurization and decarbonization apparatus. The ammonia-based desulfurization and decarbonization apparatus may be an integrated ammonia-based desulfurization and decarbonization apparatus.

In the apparatus shown in FIG. 2, process gas 1 containing sulfur oxides and CO₂ may enter the ammonia-based desulfurization system of desulfurization functional area 101 (shown in FIG. 1) and may be fed into desulfurization tower 2. Desulfurization circulating pump 5 may be used for spraying and circulation. This may cool the process gas and concentrate the ammonium sulfate solution into a slurry. The slurry, which may include solid precipitate, may be sent via ammonium sulfate discharge pump 6 to ammonium sulfate solid-liquid separator 31. The solid may be dried in ammonium sulfate drier 32, and packed in ammonium sulfate packing machine 33 to obtain product 34, which may include ammonium sulfate. Circulating pump 3 of desulfurization functional area 101 and desulfurization circulating tank 13 of desulfurization functional area 101 may be used for absorption spraying and circulation to absorb sulfur oxides (sulfur dioxide and sulfur trioxide) in the process gas. Desulfurization heat exchanger 4 may be used to control the desulfurization temperature. Desulfurization circulating pump 10 and desulfurization circulating water tank 9 may be used for washing spraying and circulation. Desulfurization heat exchanger 11 may be used to control the washing temperature and the temperature of post-desulfurization tail gas 12. Flue gas condensate 14 may be processed by membrane separation apparatus 15. Concentrated solution 16 obtained from membrane separation may be returned to desulfurization tower for use. Part 18 of purified water obtained from the membrane separation may be used as makeup water for ammonia washing tower 25. Part 17 of the purified water may be externally discharged. Ammonia 8 may be metered. Ammonia 8 may be sent to desulfurization circulating tank 13 as ammonia addition. Oxidation air 7 may be sent to desulfurization circulating tank 13 for oxidizing the ammonium sulfate solution.

Post-desulfurization tail gas 12 may enter the ammonia-based decarbonization system of decarbonization functional area 102 (shown in FIG. 1) and may be fed into decarbonization tower 19. Decarbonization circulating pump 21 may be used for absorption spraying and circulation, and a slurry may be sent by decarbonization discharge pump 22 to ammonium bicarbonate solid-liquid separator 37. The solid may be dried in ammonium bicarbonate drier 38, and packed in ammonium bicarbonate packing machine 39 to obtain product 40, which may include ammonium bicarbonate. Ammonia 24 may be metered. Ammonia 24 may be sent to decarbonization tower 19 for ammonia addition.

Post-decarbonization tail gas 23 may enter the tail gas washing system of ammonia washing functional area 103 (shown in FIG. 1) and may be fed into ammonia washing tower 25. Circulating pump 26 may be used for first-stage washing in ammonia washing tower 25. A first-stage washing fluid may come from acidic desulfurization fluid 35 of particulate washing circulating pump 20 of desulfurization circulating tank 13 and may be added to the bottom of ammonia washing tower 25. The washing fluid may be continuously added. Desulfurization fluid 36 that has absorbed ammonia in ammonia washing tower 25 may be returned to desulfurization circulating tank 13. Circulating pump 27 of ammonia washing functional area 103 and circulating water tank 28 of ammonia washing functional area 103 may be used for second-stage washing in ammonia washing tower 25. A second-stage washing fluid may come from purified water 18. After the washing, ammonia washing water drainage liquid 29 may be returned to desulfurization functional area 101 After the washing, clean flue gas 30 may be discharged.

In the apparatus shown schematically in FIG. 3, decarbonization circulating pump 21 (also shown in FIG. 2) may output a part of the ammonia-based decarbonization system's absorption spraying and circulation solution to heat exchanger 42 for heat exchange. The solution may then enter CO₂ regeneration tower 41. After the tower bottom is heated by steam from reboiler 43, a CO₂ gas may be collected at the top of the tower. The gas may be subjected to two-stage cooling by circulating water cooler 44 and chilled water cooler 45. The gas may then be sent to CO₂ buffer tank 46, and after a certain period of buffering, may be compressed by CO₂ compressor 47. Subsequently, a part of the CO₂ may be sent to downstream production apparatus 49 for production of downstream products comprising urea, soda ash, and the like. Another part may be loaded into bottles or into a tanker 48. Steam 51 may be added to the top of reboiler 43. Condensate 52 may be taken out from the bottom of reboiler 43.

Process water 53 may be added to the upper part of CO₂ regeneration tower 41. The apparatus may include heat pump system 50. The heat pump system may produce chilled water. Chilled water supply 54 may be sent to heat exchangers including desulfurization heat exchanger 4, desulfurization heat exchanger 11 (shown in FIG. 2) and chilled water cooler 45 for cooling one or more of the process gas (flue gas), CO₂ gas, and circulating fluids. Chilled water return 55 may be returned to heat pump system 50. The output of heat exchanger 42 may be provided to desulfurization tower 2 (shown in FIG. 2) of the ammonia-based desulfurization system of desulfurization functional area 101 (shown in FIG. 1). The output of heat exchanger 42 may be provided to decarbonization tower 19 (shown in FIG. 2) of the ammonia-based decarbonization system of decarbonization functional area 101 (shown in FIG. 1).

### Example 1

A coal-fired boiler flue gas (process gas) containing sulfur oxides and CO₂ was introduced into an integrated desulfurization and decarbonization apparatus. FIG. 2 shows the process flow diagram. The apparatus included desulfurization tower 2, decarbonization tower 19, and ammonia washing tower 25.

Process gas 1, which contained sulfur oxides and CO₂, entered desulfurization tower 2 of desulfurization functional area 101. Desulfurization circulating pump 5 was used for spraying and circulation, by which the process gas was cooled while the ammonium sulfate solution was concentrated. The concentrated ammonium sulfate slurry with solid precipitation was sent via ammonium sulfate discharge pump 6 to ammonium sulfate solid-liquid separator 31. The solid was dried in the ammonium sulfate dryer 32, and packed in the ammonium sulfate packing machine 33 to obtain ammonium sulfate product 34. Circulating pump 3 in desulfurization functional area 101 and desulfurization circulating tank 13 were used for absorption spraying and circulation to absorb sulfur oxides (sulfur dioxide and sulfur trioxide) in the process gas, and the desulfurization heat exchanger 4 was used to control the desulfurization temperature. Desulfurization circulating pump 10 and desulfurization circulating water tank 9 were used for washing spraying and circulation, and desulfurization heat exchanger 11 was used to control the washing temperature and the temperature of the post-desulfurization tail gas 12. Flue gas condensate 14 was processed by membrane separation apparatus 15. Concentrated solution 16 obtained from membrane separation was returned to desulfurization tower 2. Purified water was obtained from the membrane separation. Part 18 of the purified water was used as makeup water for ammonia washing tower 25, and part 17 of the purified water was discharged. Ammonia 8 was metered and provided to desulfurization circulating tank 13 for ammonia addition. Oxidation air 7 was provided to desulfurization circulating tank 13 for oxidizing the solution.

Post-desulfurization tail gas 12 entered decarbonization tower 19 of decarbonization functional area 102. Decarbonization circulating pump 21 was used for absorption spraying and circulation, and a resulting slurry was sent by decarbonization discharge pump 22 to ammonium bicarbonate solid-liquid separator 37. The resulting solid was dried in ammonium bicarbonate drier 38, and packed in ammonium bicarbonate packing machine 39 to obtain ammonium bicarbonate product 40. Ammonia 24 was metered and provided to decarbonization tower 19 for ammonia addition. Part of the ammonium sulfate-containing ammonium bicarbonate solution was returned to desulfurization functional area 101.

Post-decarbonization tail gas 23 entered ammonia washing tower 25 of ammonia washing functional area 103. Ammonia washing tower circulating pump 26 was used for first-stage washing. First-stage washing fluid coming from acidic desulfurization fluid 35 of particulate washing circulating pump 20 of desulfurization circulating tank 13 was continuously added to ammonia washing tower 25. Desulfurization fluid 36, having absorbed ammonia, was returned to desulfurization circulating tank 13. Circulating pump 27 for the ammonia washing functional area 103 and circulating water tank 28 for the ammonia washing functional area 103 were used for second-stage washing. Second-stage washing fluid came from purified water 18. After the washing, wash drainage liquid 29 was returned to desulfurization functional area 101. After the washing, clean flue gas 30 was discharged.

99.6% anhydrous ammonia was used as an absorbing agent for desulfurization and decarbonization. Process gas (boiler flue gas) parameters are given in the table below:

| No. | Item | Value |
|---|---|---|
| 1 | Flow rate, Nm³/h | 560000 |
| 2 | Temperature, ° C. | 160 |
| 3 | SO₂ content, mg/Nm³ | 4500 |
| 4 | CO₂ content, v % | 12 |
| 5 | H₂O content, v % | 5.48 |
| 6 | O₂ content, v % | 8.65 |

The main parameters of the desulfurization system are given in the table below:

| No. | Item | Value |
|---|---|---|
| 1 | Gas flow rate at outlet of desulfurization tower, | 528326 |
| | Nm³/h | |
| 2 | Temperature at outlet of desulfurization tower, ° C. | 18 |
| 3 | SO₂ content at outlet of desulfurization tower, ppm | <5 |
| 4 | CO₂ content at outlet of desulfurization tower, v % | 12.7 |
| 5 | H₂O content at outlet of desulfurization tower, v % | 2.0 |
| 6 | Output of byproduct ammonium sulfate, t/h | 5.24 |
| 7 | Desulfurization efficiency, % | 99.9 |
| 8 | Consumption of 99.6% anhydrous ammonia, t/h | 1.34 |

The main parameters of the decarbonization tower are given in the table below:

| No. | Item | Value |
|---|---|---|
| 1 | Gas flow rate at outlet of decarbonization tower, | 468360 |
| | Nm³/h | |
| 2 | CO₂ content at outlet of decarbonization tower, v % | 1.4 |
| 3 | NH₃ content at outlet of decarbonization tower, ppm | 900 |
| 4 | Decarbonization efficiency, % | 90 |
| 5 | Output of byproduct ammonium bicarbonate, t/h | 221.9 |
| 6 | Consumption of 99.6% anhydrous ammonia, t/h | 46.0 |

The main parameters of the tail gas after treatment by the ammonia washing tower are given in the table below:

| No. | Item | Value |
|---|---|---|
| 1 | Gas flow rate at outlet of ammonia washing tower, | 467940 |
| | Nm³/h | |
| 2 | CO₂ content at outlet of ammonia washing tower, v % | 1.4 |
| 3 | NH₃ content at outlet of ammonia washing tower, ppm | <3 |
| 4 | SO₂ content at outlet of ammonia washing tower, ppm | <2 |

### Example 2

A coal-fired boiler flue gas (process gas) containing sulfur oxides and CO₂ was entered into an integrated desulfurization and decarbonization apparatus. FIG. 2 and FIG. 3 show the process flow diagram. The apparatus included desulfurization tower 2, decarbonization tower 19, and ammonia washing tower 25.

Process gas 1 containing sulfur oxides and CO₂ entered desulfurization tower 2 of desulfurization functional area 101. Desulfurization circulating pump 5 was used for spraying and circulation, which cooled the process gas while concentrating the ammonium sulfate solution. The resulting concentrated ammonium sulfate slurry with solid precipitate was sent via ammonium sulfate discharge pump 6 to ammonium sulfate solid-liquid separator 31. The solid was dried in ammonium sulfate drier 32, and packed in ammonium sulfate packing machine 33 to obtain ammonium sulfate product 34. Circulating pump 3 in desulfurization functional area 101 and desulfurization circulating tank 13 were used for absorption spraying and circulation to absorb sulfur oxides (sulfur dioxide and sulfur trioxide) in the process gas, and desulfurization heat exchanger 4 was used to control the desulfurization temperature. Desulfurization circulating pump 10 and desulfurization circulating water tank 9 were used for washing spraying and circulation. Desulfurization heat exchanger 11 was used to control the washing temperature and the temperature of post-desulfurization tail gas 12. Flue gas condensate 14 was processed by membrane separation apparatus 15. Concentrated solution 16 obtained from membrane separation was returned to desulfurization tower 2. Purified water was obtained from the membrane separation. Part 18 of the purified water was used as makeup water for ammonia washing tower 25, and part 17 of the purified water was discharged. Ammonia 8 was metered and then provided to desulfurization circulating tank 13 as ammonia addition. Oxidation air 7 was provided to desulfurization circulating tank 13 for oxidizing the solution.

Post-desulfurization tail gas 12 entered decarbonization tower 19 of decarbonization functional area 102. Decarbonization circulating pump 21 was used for absorption spraying and circulation, and a resulting slurry was sent by decarbonization discharge pump 22 to ammonium bicarbonate solid-liquid separator 37. The resulting solid was dried in ammonium bicarbonate drier 38, and packed in ammonium bicarbonate packing machine 39 to obtain ammonium bicarbonate product 40. Ammonia 24 was metered and then provided to decarbonization tower 19 as ammonia addition. Part of the ammonium sulfate-containing ammonium bicarbonate solution was returned to desulfurization functional area 101.

Post-decarbonization tail gas 23 entered ammonia washing tower 25 of ammonia washing functional area 103. Circulating pump 26 for ammonia washing tower 25 was used for first-stage washing. First-stage washing fluid coming from acidic desulfurization fluid 35 of particulate washing circulating pump 20 of desulfurization circulating tank 13 was continuously added to ammonia washing tower 25. Desulfurization fluid 36, having-absorbed ammonia, was returned to desulfurization circulating tank 13. Circulating pump 27 for ammonia washing functional area 103 and circulating water tank 28 for ammonia washing functional area 103 were used for second-stage washing. Second-stage washing fluid came from purified water 18. After the washing, wash drainage liquid 29 was returned to desulfurization functional area 101. After the washing, clean flue gas 30 was discharged.

The apparatus included CO₂ regeneration tower 41 in which the decarbonization circulating fluid was regenerated. Operating parameters of CO₂ regeneration tower 41 were: 100-130° C. at tower bottom, 60-90° C. at tower top, an operating pressure of 0.3-0.4 MPa at tower bottom, and a gas velocity of 0.6-0.8 m/s.

The apparatus included solution heat exchanger 42, reboiler 43, circulating water cooler 44, chilled water cooler 45, CO₂ buffer tank 46, and CO₂ compressor 47.

Solution extracted at the outlet of decarbonization circulating pump 21 was sent to solution heat exchanger 42 before entering CO₂ regeneration tower 41. The solution at the bottom of tower 41 was heated by steam in reboiler 43, and CO₂ gas was collected at the top of tower 41. The gas was cooled in two-stage cooling by circulating water cooler 44 and chilled water cooler 45, before being sent to CO₂ buffer tank 46. CO₂ from buffer tank 46 was compressed by CO₂ compressor 47, and subsequently 10% thereof was sent to CO₂ downstream production apparatus 49 for production of polycarbonate, 5% was loaded into bottles or into tanker 48, and 85% was sent for sequestration.

Condensate 52 was taken out from the bottom of reboiler 43.

Process water 53 was added to the upper part of CO₂ regeneration tower 41.

The apparatus included heat pump system 50. Heat pump system 50 produced chilled water. Chilled water supply 54 was sent to heat exchangers including chilled water cooler 45, desulfurization heat exchanger 4 and desulfurization heat exchanger 11 for the cooling of CO₂ gas and circulating fluids. Chilled water return 55 was returned to heat pump system 50.

99.6% anhydrous ammonia was used as an absorbing agent for flue gas desulfurization and decarbonization for a 600 MW unit. Process gas (boiler flue gas) parameters are given in the table below:

| No. | Item | Value |
|---|---|---|
| 1 | Flue gas flow rate, Nm³/h | 2100000 |
| 2 | Temperature, ° C. | 150 |
| 3 | SO₂ content, mg/Nm³ | 7000 |
| 4 | CO₂ content, v % | 12 |
| 5 | H₂O content, v % | 6.1 |
| 6 | O₂ content, v % | 5.9 |

The main parameters of the desulfurization system are given in the table below:

| No. | Item | Value |
|---|---|---|
| 1 | Gas flow rate at outlet of desulfurization tower, Nm³/h | 1923557 |
| 2 | Temperature at outlet of desulfurization tower, ° C. | 18 |
| 3 | SO₂ content at outlet of desulfurization tower, ppm | <10 |
| 4 | CO₂ content at outlet of desulfurization tower, v % | 13.1 |
| 5 | H₂O content at outlet of desulfurization tower, v % | 2.0 |
| 6 | Output of byproduct ammonium sulfate, t/h | 30.6 |
| 7 | Desulfurization efficiency, % | 99.9 |
| 8 | Consumption of 99.6% anhydrous ammonia, t/h | 7.8 |

The main parameters of the decarbonization tower are given in the table below:

| No. | Item | Value |
|---|---|---|
| 1 | Gas flow rate at outlet of decarbonization tower, | 1698128 |
| | Nm³/h | |
| 2 | CO₂ content at outlet of decarbonization tower, v % | 1.48 |
| 3 | NH₃ content at outlet of decarbonization tower, ppm | 800 |
| 4 | Decarbonization efficiency, % | 90 |
| 5 | Output of byproduct ammonium bicarbonate, t/h | 83.3 |
| 6 | Consumption of 99.6% anhydrous ammonia, t/h | 17.3 |

The main parameters of the tail gas after treatment by the ammonia washing tower are given in the table below:

| No. | Item | Value |
|---|---|---|
| 1 | Gas flow rate at outlet of ammonia | 1696783 |
| | washing tower, Nm³/h | |
| 2 | CO₂ content at outlet of ammonia | 1.49 |
| | washing tower, v % | |
| 3 | NH₃ content at outlet of ammonia | <8 |
| | washing tower, ppm | |
| 4 | SO₂ content at outlet of ammonia | <2 |
| | washing tower, ppm | |

The main parameters of the CO₂ gas after regeneration by the CO₂ regeneration tower and the two-stage cooling are given in the table below:

| No. | Item | Value |
|---|---|---|
| 1 | Gas flow rate, Nm³/h | 204313 |
| 2 | CO₂ content, v % | 99.9 |
| 3 | NH₃ content in the gas, ppm | <20 |
| 4 | Water content in the gas, ppm | <500 |
| 5 | Gas pressure, MPa | 0.3 |

### Selected Embodiments

1. An ammonia desulfurization and decarbonization method using ammonia to remove sulfur oxides and CO₂ in process gas, characterized in that the method sequentially comprises the following steps:
1) removing part of SO₂ in the process gas with a desulfurization circulating fluid;
2) removing part of CO₂ in the process gas with a decarbonization circulating fluid; and
3) removing part of free ammonia in the process gas with the desulfurization circulating fluid, and returning the desulfurization circulating fluid to a desulfurization apparatus.

2. The method according to selected embodiment 1, characterized by at least one of the following:
products comprise ammonium sulfate and ammonium bicarbonate fertilizers; and
the CO₂ removal rate in step 2) is 30-98%.

3. The method according to selected embodiment 1, characterized in that the steps further comprise:
sending part of the decarbonization circulating fluid to an ammonium bicarbonate post-processing apparatus to produce ammonium bicarbonate fertilizer,
and/or sending part of the decarbonization circulating fluid to a CO₂ regeneration apparatus for regeneration to obtain gaseous CO₂,
wherein regeneration of the decarbonization circulating fluid proceeds in a CO₂ regeneration system that includes a tower top and a tower bottom, the system with the following operating parameters: the regeneration temperature is 90-150° C. and preferably 100-130° C. at tower bottom, and 6-100° C. and preferably 70-90° C. at tower top; the regeneration pressure is 0.2-0.7 MPa and preferably 0.3-0.5 MPa at tower bottom; and the regeneration tower gas velocity is 0.2-3 m/s and preferably 0.3-2 m/s.

4. The method according to selected embodiment 1, characterized in that part of the gaseous CO₂ is used for production of downstream products or oil displacement, the downstream products comprising urea, soda ash, sodium bicarbonate, polycarbonate, food CO₂, CO₂ gas fertilizer, potassium bicarbonate, and the like, and/or part of the CO₂ is used for marine sequestration or underground sequestration.

5. The method according to selected embodiment 1, characterized in that the method further comprises step 4) between step 2) and step 3) in which process water is used to remove part of free ammonia in the process gas, and/or further comprises step 5) after step 3) in which the process water is used to further remove part of free ammonia in the process gas.

6. The method according to selected embodiment 1, characterized in that the desulfurization circulating fluid comprises a concentrated circulating fluid and an absorbing circulating fluid,
the concentrated circulating fluid has
a pH of 1-6 and preferably 2-4.5,
ammonium sulfite at a concentration of 0-0.2%, and
ammonium sulfate at a concentration of 10-60%, and
the absorbing circulating fluid has
a pH of 4.5-6.5 and preferably 4.8-6.2,
ammonium sulfite at a concentration of 0.1-3%, and
ammonium sulfate at a concentration of 10-38%.

7. The method according to selected embodiment 1, characterized in that the decarbonization circulating fluid has a pH of 7-13, preferably 7.5-11, and more preferably 8-9.5, ammonium bicarbonate at a concentration of 3-40% and preferably 10-22%, and an NH₃/CO₂ molar ratio of 0.6-4, preferably 1.2-3, and more preferably 2-2.5.

8. The method according to selected embodiment 1, characterized in that the desulfurization absorption temperature is 5-55° C., preferably 15-50° C., and more preferably 20-40° C.; and the decarbonization absorption temperature is 0-45° C., preferably 5-40° C., and more preferably 10-30° C.

9. An apparatus for implementing the method according to any one of selected embodiments 1-8, characterized in that an ammonia desulfurization functional area, an ammonia decarbonization functional area, an ammonia washing functional area, an ammonium sulfate post-processing system, and an ammonium bicarbonate post-processing system are provided; ammonium is used as a desulfurizing and decarbonizing agent; process gas first enters the desulfurization functional area for desulfurization to produce an ammonium sulfate fertilizer; the desulfurized process gas enters the decarbonization functional area to remove carbon dioxide in the process gas and produce an ammonium bicarbonate-containing solution/slurry; the decarbonized process gas contains free ammonia and enters the ammonia washing functional area for washing with a desulfurization circulating fluid and then with the process water; after the washing, the ammonia-containing desulfurization solution and process water solution are returned to the desulfurization functional area and serve as an absorbing agent for desulfurization; and part of the ammonium sulfate-containing ammonium bicarbonate solution is returned to the desulfurization functional area.

10. The apparatus according to selected embodiment 9, characterized in that the ammonia washing functional area further comprises washing with the process water before washing with the desulfurization circulating fluid, and the ammonia desulfurization functional area, the ammonia decarbonization functional area, and the ammonia washing functional area are combined in one tower or multiple towers.

11. The apparatus according to selected embodiment 9, characterized in that the desulfurization functional area is divided into a plurality of segments, comprising a cooling and concentrating segment, an absorbing segment, and a particulate removing segment, each segment being provided with at least one spraying layer, and a device/part allowing gas to pass through being arranged between the segments.

12. The apparatus according to selected embodiment 11, characterized in that the particulate removing segment is divided into two parts; for spray washing in the first part, an ammonium sulfate-containing concentrated solution is used for circulated washing; an ammonium sulfate-containing dilute solution is used in the second part for circulated washing; and a device/part allowing gas to pass through is arranged between the two parts; the concentration of the concentrated ammonium sulfate solution in the first part is controlled at 10-38%, preferably 12-30%, and the pH is controlled at 2.5-7.5, preferably 3-5.5; and the concentration of the dilute ammonium sulfate solution in the second part is controlled at 0-5%, preferably 0.02-2%, and the pH is controlled at 3-7.

13. The apparatus according to selected embodiment 11, characterized in that the desulfurization functional area is provided with a cooling apparatus to control the temperature of desulfurized flue gas at 5-55° C., preferably 15-50° C., and more preferably 20-40° C.

14. The apparatus according to selected embodiment 11, characterized in that the decarbonization functional area is provided with a cooling apparatus to control the temperature of decarbonized flue gas at 0-45° C., preferably 5-40° C., and more preferably 10-30° C.

15. The apparatus according to selected embodiment 13, characterized by at least one of the following: the cooling apparatus is arranged on the circulating pipeline for the desulfurization circulating fluid to cool the spraying and circulating desulfurization fluid and to further cool the desulfurized flue gas; or the cooling apparatus is arranged on the process gas pipe/flue in the desulfurization functional area to directly cool the gas; and circulating water and/or chilled water is used as a cooling agent.

16. The apparatus according to selected embodiment 9, characterized by at least one of the following:
the ammonia washing circulating solution is taken from the ammonia desulfurization functional area to wash ammonia, and then returned to the ammonia desulfurization functional area for desulfurization, and the pH of the ammonium sulfate washing solution is controlled at 2.5-7.5; and
part of the water solution absorbed during the ammonia washing circulation enters replenishing water for the circulating fluid for the particulate removing segment of the desulfurization functional area, and the ammonia concentration in the ammonia washing circulating solution is controlled at 0-5%, preferably 0-1%.

17. The apparatus according to selected embodiment 12, characterized in that part of the dilute ammonium sulfate solution is pumped out and sent to a purification membrane separation apparatus, the produced purified water is used as replenishing water for the deamination and washing functional area and the excess part is for external use to control the ammonia concentration in the washing water and the concentration of the dilute ammonium sulfate solution for desulfurization and washing, and the concentrated water enters a desulfurization absorption area.

18. The apparatus according to selected embodiment 9, characterized by at least one of the following:
desulfurization, decarbonization, and ammonia washing functional areas, wherein one or a combination of spraying absorption, plate absorption, filler absorption, and float valve absorption is adopted in the decarbonization functional area;
the ammonium sulfate slurry produced from desulfurization is packed into a product after solid-liquid separation and drying, or is output directly as a wet product;
the ammonium bicarbonate slurry produced from decarbonization is partially packed into a product after solid-liquid separation and drying, or is output directly as a wet product; the solution obtained from the separation is returned to the decarbonization apparatus; and
the ammonium bicarbonate slurry or ammonium bicarbonate solution produced from decarbonization is further heated, partially or wholly, to produce CO₂ and an ammonia solution, the ammonia solution is returned to the decarbonization functional area for further use, and CO₂ is used for production of downstream products, oil displacement, beverage production, sequestration, and the like.

19. The apparatus according to selected embodiment 9, characterized in that main parameters of the ammonia desulfurization functional area are as follows:
1) empty tower gas velocity controlled at 0.5-5 m/s, preferably 2-4 m/s;
2) circulating fluid spraying density of each layer at 4-100 m³/m²·h, preferably 8-80 m³/m²·h;
3) circulating fluid temperature controlled at 5-55° C., preferably 20-40° C.; and
4) circulating fluid pH controlled at 1-7.

20. The apparatus according to selected embodiment 9, characterized in that main parameters of the decarbonization functional area are as follows:
1) empty tower gas velocity controlled at 0.1-5 m/s;
2) temperature controlled at 5-40° C., preferably 10-30° C.; and
3) circulating fluid pH controlled at 7-11.

21. The apparatus according to selected embodiment 9, characterized in that main parameters of the ammonia washing functional area are as follows:
1) empty tower gas velocity controlled at 0.25-5 m/s;
2) temperature controlled at 0-50° C., preferably 3-40° C.; and
3) circulating fluid pH controlled at 3-10.

22. The apparatus according to selected embodiment 9, further comprising a heat pump system, wherein the heat pump system provides the chilled water required for cooling, and the temperature of the chilled water obtained by the heat pump is 3-25° C., preferably 5-10° C.

23. The apparatus according to selected embodiment 9, further comprising a CO₂ regeneration tower having a tower top and a tower bottom, wherein regeneration of the decarbonization circulating fluid proceeds in the CO₂ regeneration tower.

24. The apparatus according to selected embodiment 23, characterized in that the operating parameters are as follows: the regeneration temperature is 90-150° C. and preferably 100-130° C. at tower bottom, and 6-100° C. and preferably 70-90° C. at tower top; the regeneration pressure is 0.2-0.7 MPa and preferably 0.3-0.5 MPa at tower bottom; and the regeneration tower gas velocity is 0.2-3 m/s and preferably 0.3-2 m/s.

25. The apparatus according to selected embodiment 23, characterized in that a process water inlet is provided on an upper part of the regeneration tower.

26. The apparatus according to selected embodiment 23, characterized in that the gaseous CO₂ obtained by the regeneration tower is partially used for production of downstream products comprising urea, soda ash, sodium bicarbonate, polycarbonate, food CO₂, CO₂ gas fertilizer, potassium bicarbonate, and the like, partially used for oil displacement, beverage production, and gas welding, and partially used for marine sequestration or underground sequestration.

27. The apparatus according to selected embodiment 23, further comprising a solution heat exchanger, a reboiler, a circulating water cooler, a chilled water cooler, a CO₂ buffer tank, and a CO₂ compressor, wherein the decarbonization circulating pump outputs a part of the solution to the solution heat exchanger for heat exchange, the solution then enters the CO₂ regeneration tower, the CO₂ gas collected at the top of the tower is cooled by the coolers, then sent to the CO₂ buffer tank, and is sent out after compression by the CO₂ compressor.

Thus, apparatus and methods for desulfurization and decarbonization have been provided. Persons skilled in the art will appreciate that the present invention may be practiced by other than the described embodiments, which are presented for purposes of illustration rather than of limitation. The present invention is limited only by the claims that follow.

What is claimed is:

1. A desulfurization and decarbonization method using ammonia to remove sulfur oxides and CO₂ in process gas that is fed into a desulfurization apparatus, the method comprising:
in order:
1) removing, using desulfurization circulating fluid, SO₂ from the process gas.
2) removing, using a decarbonization circulating fluid, CO₂ from the process gas; and
3) removing, using desulfurization circulating fluid, free ammonia from the process gas; and
returning the desulfurization circulating fluid to the desulfurization apparatus.

2. The method of claim 1 further comprising producing fertilizer.

3. The method of claim 2 wherein the fertilizer includes ammonium sulfate.

4. The method of claim 2 wherein the fertilizer includes ammonium bicarbonate fertilizers.

5. The method of claim 1 wherein the removing CO₂ removes from 30-98% of the CO₂.

6. The method of claim 1 further comprising:
producing from the decarbonization circulating fluid ammonium bicarbonate fertilizer; and
regenerating gaseous CO₂ from the decarbonization circulating fluid; wherein the regenerating is performed in a regeneration system having a tower that includes a tower bottom and a tower top.

7. The method of claim 6 wherein an operating temperature at the tower bottom is in a range from 90-150° C.

8. The method of claim 7 wherein the range is from 100-130° C.

9. The method of claim 6 wherein an operating temperature at the tower top is in a range from 6-100° C.

10. The method of claim 9 wherein the range is from 70-90° C.

11. The method of claim 6 wherein a regeneration pressure at the tower bottom is in a range from 0.2-0.7 MPa.

12. The method of claim 11 wherein the range is from 0.3-0.5 MPa.

13. The method of claim 6 further comprising flowing gas in the tower at a gas velocity in a range from 0.2-3 m/s.

14. The method of claim 13 wherein the range is 0.3-2 m/s.

15. The method of claim 1 further comprising producing from the decarbonization circulating fluid ammonium bicarbonate fertilizer.

16. The method of claim 1 further comprising producing, from gaseous CO₂ removed from the process gas, a downstream product.

17. The method of claim 16 wherein the downstream product includes urea.

18. The method of claim 16 wherein the downstream product includes soda ash.

19. The method of claim 16 wherein the downstream product includes sodium bicarbonate.

20. The method of claim 16 wherein the downstream product includes polycarbonate.

21. The method of claim 16 wherein the downstream product includes CO₂ gas fertilizer.

22. The method of claim 16 wherein the downstream product includes potassium bicarbonate.

23. The method of claim 16 wherein the downstream product includes food-grade CO₂.

24. The method of claim 1 further comprising recovering, using gaseous CO₂ removed from the process gas, oil.

25. The method of claim 24 further comprising sequestering gaseous CO₂ removed from the process gas.

26. The method of claim 25 wherein the sequestering includes performing marine sequestration.

27. The method of claim 25 wherein the sequestering includes performing underground sequestration.

28. The method of claim 1 further comprising sequestering gaseous CO₂ removed from the process gas.

29. The method of claim 28 wherein the sequestering includes performing marine sequestration.

30. The method of claim 28 wherein the sequestering includes performing underground sequestration.

31. The method of claim 1 further comprising:
between step 2) and step 3), removing, using process water, free ammonia from the process gas; and,
after step 3), removing, using process water, free ammonia from the process gas.

32. The method of claim 1 further comprising, after step 3), removing, using process water, free ammonia from the process gas.

33. The method of claim 1 wherein:
the desulfurization circulating fluid comprises:
a concentrated circulating fluid and;
an absorbing circulating fluid;
the concentrated circulating fluid has:
ammonium sulfite at a concentration of 0-0.2%; and
ammonium sulfate at a concentration of 10-60%; and
the absorbing circulating fluid has:
ammonium sulfite at a concentration of 0.1-3%; and
ammonium sulfate at a concentration of 10-38%.

34. The method of claim 33 wherein:
the concentrated circulating fluid has a pH of 1-6; and
the absorbing circulating fluid has a pH of 4.5-6.5.

35. (canceled)

36. The method of claim 33 wherein:
the concentrated circulating fluid has a pH of 2-4.5; and
the absorbing circulating fluid has a pH of 4.8-6.2.

37. The method of claim 1 wherein the decarbonization circulating fluid has:
a pH of 7-13;
ammonium bicarbonate at a concentration of 3-40%; and
an NH₃/CO₂ molar ratio of 0.6-4.

38-42. (canceled)

43. The method of claim 1 wherein the decarbonization circulating fluid has:
a pH of 7.5-11;
ammonium bicarbonate at a concentration of 3-40%; and
an NH₃/CO₂ molar ratio of 0.6-4.

44-48. (canceled)

49. The method of claim 1 wherein the decarbonization circulating fluid has:
a pH of 8-9.5;
ammonium bicarbonate at a concentration of 3-40%; and
an NH₃/CO₂ molar ratio of 0.6-4.

50-51. (canceled)

52. The method of claim 1 wherein the decarbonization circulating fluid has:
a pH of 8-9.5;
ammonium bicarbonate at a concentration of 10-22%; and
an NH₃/CO₂ molar ratio of 0.6-4.

53. The method of claim 1 wherein the decarbonization circulating fluid has:
a pH of 8-9.5;
ammonium bicarbonate at a concentration of 10-22%; and
an NH₃/CO₂ molar ratio of 1.2-3.

54. The method of claim 1 wherein the decarbonization circulating fluid has:
a pH of 8-9.5;
ammonium bicarbonate at a concentration of 10-22%; and
an NH₃/CO₂ molar ratio of 2-2.5.

55. The method of claim 1 wherein:
the desulfurization includes absorbing SO₂ at a temperature in a range from 5-55° C.; and
the decarbonization includes absorbing CO₂ at a temperature in a range from 0-45° C.

56-58. (canceled)

59. The method of claim 1 wherein:
the desulfurization includes absorbing SO₂ at a temperature in a range from 15-50° C.; and
the decarbonization includes absorbing CO₂ at a temperature in a range from 5-40 CC.

60-62. (canceled)

63. The method of claim 1 wherein:
the desulfurization includes absorbing SO₂ at a temperature in a range from 20-40° C.; and
the decarbonization includes absorbing CO₂ at a temperature in a range from 10-30° C.

64. Apparatus for implementing the method of claim 1, the apparatus comprising:
an ammonia-based desulfurization functional area that is configured to apply a desulfurizing agent to a process gas;
an ammonia-based decarbonization functional area that is configured to apply a decarbonizing agent to the process gas;
an ammonia washing functional area;
an ammonium sulfate post-processing system; and
an ammonium bicarbonate post-processing system;
wherein:
the desulfurizing agent is ammonium;
the decarbonizing agent is ammonium;
the desulfurization functional area is further configured to:
receive the process gas; and
desulfurize the process gas;
the decarbonization functional area is further configured to:
receive the process gas after the process gas exits the desulfurization functional area;
remove carbon dioxide from the process gas; and
produce an ammonium bicarbonate-containing material;
the ammonia washing functional area is configured to:
receive process gas after the process gas exits the decarbonization functional area;
wash the process gas with a desulfurization circulating fluid; and, then,
wash the process gas with process water; and
the desulfurization functional area is further configured to:
receive the process gas after the process gas exits the ammonia washing functional area;
receive the process water after the process water exits the ammonia washing functional area;
spray the process gas and the process water as an absorbing agent for desulfurization; and
receive ammonium sulfate-containing ammonium bicarbonate solution after the ammonium bicarbonate solution exits the decarbonization functional area.

65. The apparatus of claim 64 wherein the process gas includes free ammonia.

66. The apparatus of claim 64 wherein:
the ammonia washing functional area is further configured to wash the process gas with the process water before washing the process gas with the desulfurization circulating fluid; and
the ammonia-based desulfurization functional area, the ammonia-based decarbonization functional area, and the ammonia washing functional area are disposed in a tower.

67. The apparatus of claim 64 wherein the desulfurization functional area includes:
a cooling and concentrating segment that includes a first spraying layer;
an absorbing segment that:
includes a second spraying layer; and
is in fluid communication with the cooling and concentrating segment via a first device that is configured to allow gas to pass; and
a particulate removing segment that is in fluid communication with the absorbing segment via a second device that is configured to allow gas to pass;
wherein each of the segments:
includes at least one spraying layer; and
is in fluid communication with another segment via a device that is configured to allow gas to pass.

68. The apparatus of claim 67 further comprising, in the particulate removing segment:
a first washing part configured to wash with concentrated, circulating ammonium sulfate-containing solution; and
a second washing part that:
is configured to wash with dilute, circulating ammonium sulfate-containing solution; and
is in fluid communication with the first washing part via a device that allows gas to pass.

69. The apparatus of claim 68 wherein:
the first part is further configured to maintain:
an ammonium sulfate concentration of the concentrated ammonium sulfate-containing solution in a range that is 10-38%; and
a pH of the concentrated ammonium sulfate-containing solution in a range that is 2.5-7.5; and
the second part is further configured to maintain:
an ammonium sulfate concentration of the dilute ammonium sulfate-containing solution in a range that is 0-5%; and
a pH of the dilute ammonium sulfate-containing solution in a range that is 3-7.

70-75. (canceled)

76. The apparatus of claim 68 wherein:
the first part is further configured to maintain:
an ammonium sulfate concentration of the concentrated ammonium sulfate-containing solution in a range that is 12-30%; and
a pH concentrated ammonium sulfate-containing solution in a range that is 3-5.5; and
the second part is further configured to maintain:
an ammonium sulfate concentration of the dilute ammonium sulfate-containing solution in a range that is 0.02-2%; and
a pH of the dilute ammonium sulfate-containing solution in a range that is 3-7.

77. The apparatus of claim 67 wherein the desulfurization functional area includes a cooling apparatus that is configured to maintain a temperature of process gas in a range that is 5-55° C.

78. The apparatus of claim 77 wherein the range is 15-50° C.

79. The apparatus of claim 77 wherein the range is 20-40° C.

80. The apparatus of claim 67 wherein the decarbonization functional area includes a cooling apparatus that is configured to maintain a temperature of process gas in a range that is 0-45° C.

81. The apparatus of claim 80 wherein the range is 5-40° C.

82. The apparatus of claim 80 wherein the range is 10-30° C.

83. The apparatus of claim 77 further comprising a circulating pipeline configured to transport desulfurization circulating fluid;
wherein:
the cooling apparatus is:
arranged on the circulating pipeline; and
configured to:
cool:
the circulating desulfurization fluid; and
the process gas; and
circulate water as a coolant.

84. The apparatus of claim 83 further comprising a process gas conduit;
wherein the cooling apparatus is:
arranged on the process gas conduit; and
configured to cool the process gas.

85. The apparatus of claim 84 wherein the cooling apparatus is further configured to circulate water as a coolant.

86. The apparatus of claim 64 wherein:
the ammonia washing functional area is further configured to:
(A)
receive desulfurization fluid from the ammonia-based desulfurization functional area;
using the desulfurization fluid, absorb ammonia from post-decarbonization process gas; and, then,
return the desulfurization fluid to the desulfurization functional area; and
(B)
collect aqueous solution during ammonia washing;
provide the aqueous solution to the desulfurization functional area;
the desulfurization functional area is further configured to use:
the returned desulfurization fluid to desulfurize the process gas; and
the provided aqueous solution for particle removal; and
a pH of ammonium sulfate washing solution is controlled at 2.5-7.5.

87. The apparatus of claim 86 wherein an ammonia concentration in an ammonia washing circulating solution in the ammonia washing functional area is controlled at 0-5%.

88. The apparatus of claim 86 wherein an ammonia concentration in an ammonia washing circulating solution in the ammonia washing functional area is controlled at 0-1%.

89. The apparatus of claim 68 further comprising:
a purification membrane separation apparatus; and
a conduit;
wherein:
the particulate removing segment is configured to provide dilute ammonium sulfate solution;
the purification membrane separation apparatus is configured to:
receive the dilute ammonium sulfate solution; and
produce purified water from the dilute ammonium sulfate solution; and
the conduit is configured to convey a fraction of the purified water to the ammonia washing functional area.

90. The apparatus of claim 89 wherein the ammonia washing functional area is further configured to use the purified water to replenish circulating washing water in the ammonia washing functional area.

91. The apparatus of claim 90 wherein the ammonia washing functional area is further configured to use the purified water to control a concentration of ammonia in the washing water.

92. The apparatus of claim 90 wherein the ammonia washing functional area is further configured to use the purified water to control a concentration of ammonium sulfate solution for return to the desulfurization functional area.

93. The apparatus of claim 89 further comprising, when the conduit is a first conduit, a second conduit that is configured to convey concentrated solution to a desulfurization absorption area of the desulfurization functional area.

94. The apparatus of claim 64 further comprising an ammonium bicarbonate post-processing system;
wherein:
the decarbonization functional area is further configured to produce an ammonium bicarbonate slurry; and
the ammonium bicarbonate post-processing system is configured to:
remove solution from the slurry;
pack the slurry into a product; and
and return the solution to the decarbonization functional area.

95. The apparatus of claim 94 further comprising a CO₂ regeneration system that is configured to:
heat ammonium bicarbonate from the decarbonization functional area to produce:
CO₂; and
an ammonia solution; and
provide the ammonia solution to the decarbonization functional area.

96. The apparatus of claim 64 wherein the ammonia-based desulfurization functional area is further configured to control:
a gas velocity at 0.5-5 m/s;
a circulating fluid spraying density for a spray layer at 4-100 m³/m²-h;
a circulating fluid temperature at 5-55° C.; and
a circulating fluid pH at 1-7.

97-102. (canceled)

103. The apparatus of claim 64 wherein the ammonia-based desulfurization functional area is further configured to control:
a gas velocity at 2-4 m/s;
a circulating fluid spraying density for a spray layer at 8-80 m³/m²-h;
a circulating fluid temperature at 20-40° C.; and
a circulating fluid pH at 1-7.

104. The apparatus of claim 64 wherein the ammonia-based decarbonization functional areas is further configured to control:
a gas velocity at 2-4 m/s;
a gas temperature at 5-40° C.; and
circulating fluid pH at 7-11.

105. The apparatus of claim 64 wherein the ammonia-based decarbonization functional areas is further configured to control:
a gas velocity at 2-4 m/s;
a gas temperature at 10-30° C.; and
circulating fluid pH at 7-11.

106. The apparatus of claim 64 wherein the ammonia washing functional area is further configured to control:
a velocity at 0.25-5 m/s;
a temperature at 0-50° C.; and
a circulating fluid pH at 3-10.

107. The apparatus of claim 64 wherein the ammonia washing functional area is further configured to control:
a velocity at 0.25-5 m/s;
a temperature at 3-40° C.; and
a circulating fluid pH at 3-10.

108. The apparatus of claim 64 further comprising a heat pump system that that is configured to:
receive water, at a temperature from 3-25° C., from a chilled water cooler that is in thermal communication with the CO₂; and
return the chilled water to the chilled water cooler.

109. The apparatus of claim 64 further comprising a heat pump system that that is configured to:
receive water, at a temperature from 5-10° C., from a chilled water cooler that is in thermal communication with the CO₂; and
return the chilled water to the chilled water cooler.

110. The apparatus of claim 64 further comprising a CO₂ regeneration tower that is configured to:
extract CO₂ from the process gas; and
maintain:
a temperature of the process gas at a bottom of the tower at 90-150° C.;
a temperature of the process gas at a top of the tower at 6-100° C.;
a pressure of the process gas at a bottom of the tower at 0.2-0.7 MPa; and
a gas velocity at 0.2-3 m/s.

111-124. (canceled)

125. The apparatus of claim 64 further comprising a CO₂ regeneration tower that is configured to:
extract CO₂ from the process gas; and
maintain:
a temperature of the process gas at a bottom of the tower at 100-130° C.;
a temperature of the process gas at a top of the tower at 70-90° C.;
a pressure of the process gas at a bottom of the tower at 0.3-0.5 MPa; and
a gas velocity at 0.3-2 m/s.

126. The apparatus of claim 64 further comprising a process water inlet that is disposed on an upper part of a CO₂ regeneration tower.

127. The apparatus of claim 64 further comprising:
a solution heat exchanger;
a reboiler;
a circulating water cooler;
a chilled water cooler in fluid communication with the circulating water cooler;
a CO₂ buffer tank, and
a CO₂ compressor,
wherein:
a decarbonization circulating pump provides a fraction of the bicarbonate-containing material, via the solution heat exchanger, to a CO₂ regeneration tower;
the chilled water cooler is configured to receive CO₂, via the circulating water cooler, from a top of the tower; and
the CO₂ compressor is configured to:
receive CO₂, via the CO₂ buffer tank, from the chilled water cooler,
compress the CO₂; and
discharge the CO₂.
